(19) United States
(12) Patent Application Publication
(10) Pub. No.: US 2019/0061462 A1
(43) Pub. Date: Feb. 28, 2019

(54) Electric Vehicle Resilient Thermal Management for Cooling System During Fail Operational

(71) Applicant: NIO USA, Inc., San Jose, CA (US)

(72) Inventors: Joshua Smith, Los Gatos, CA (US); Rick Rajaie, Rochester Hills, MI (US); Armando Mendez Abrego, Sunnyvale, CA (US)

(21) Appl. No.: 15/686,513

(22) Filed: Aug. 25, 2017

(51) Int. Cl. B60H 1/00; B60L 3/12; B60K 11/02

(52) U.S. Cl. CPC B60H 1/00271; B60L 3/12; B60H 2001/00307; B60H 1/00392; B60K 11/02

(57) ABSTRACT

A vehicle includes a first coolant pump, a first set of coolant plumbing coupled with the first coolant pump and a first set of one or more thermal sources (the first coolant pump operates to circulate coolant through the first set of coolant plumbing to the first set of one or more thermal sources), a second coolant pump, a second set of coolant plumbing coupled with the second coolant pump and a second set of one or more thermal sources (the second coolant pump operates to circulate coolant through the second set of coolant plumbing to the second set of one or more thermal sources) and a plurality of valves coupled with the first set of coolant plumbing and the second set of coolant plumbing. The plurality of valves operates in a plurality of modes to redirect coolant flow through the first set of coolant plumbing and the second set of coolant plumbing.

### FIELD

The present disclosure is generally directed to vehicle cooling systems, and in particular, toward cooling systems for electric and/or hybrid-electric vehicles which provide resiliency in case of an operational failure of a component of the cooling system.

### BACKGROUND

Thermal management through liquid coolant circuits are vital for electric vehicle operation. The coolant system is especially critical to support the resilient and fail-operational function of the powertrain during complete- or partial-coolant system failures. In general, the liquid cooling system comprising coolant and plumbing extracts thermal energy from batteries, motors, inverters and other modules to vehicle's heat exchangers to maintain the components' operational temperatures. Coolant pumps serve to move the coolant fluid to transport and transfer the heat from various components to heat exchangers. Therefore, in the event of a pump failure, the liquid coolant stops moving in the circuit. During such a pumping failure, the heat from components will not be extracted causing damage to vital components due to limited or completely interrupted thermal management.

To avoid cooling system failures, redundant components and systems are often employed. For example, each pump in the cooling system can have a back-up or redundant pump connected in series so that if one of these pumps fails, the other can continue to circulate coolant through the system. However, having complete redundancy significantly increases the cost and complexity of the cooling system. Such redundancy also significantly increases the total mass of the cooling system which, in an electric vehicle, negatively impacts the range of the vehicle. Therefore, to minimize system cost, mass and complexity, it is desirable to minimize the number of coolant loops and correspondingly coolant pumps.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3 shows a plan view of the vehicle in accordance with embodiments of the present disclosure;

FIG. 4 is a block diagram illustrating an exemplary communication environment of the vehicle in accordance with embodiments of the present disclosure;

FIG. 5 is a schematic illustrating a topology of an exemplary vehicle cooling system according to one embodiment of the present disclosure;

FIG. 6 is a schematic illustrating the exemplary vehicle cooling system in a normal operation mode according to one embodiment of the present disclosure;

FIG. 7 is a schematic illustrating the exemplary vehicle cooling system in a first failure operation mode according to one embodiment of the present disclosure;

FIG. 8 is a schematic illustrating the exemplary vehicle cooling system in a second failure operation mode according to one embodiment of the present disclosure; and

FIG. 9 is a flowchart illustrating an exemplary process for controlling a vehicle cooling system according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

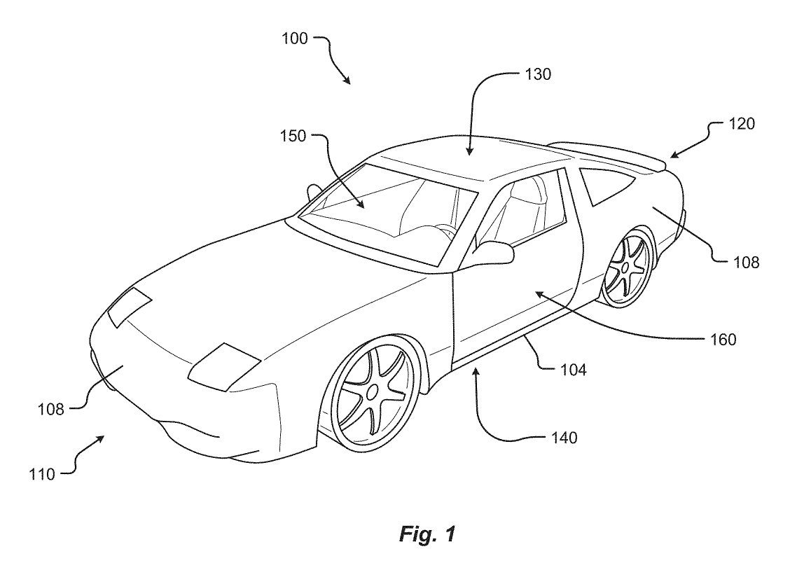

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

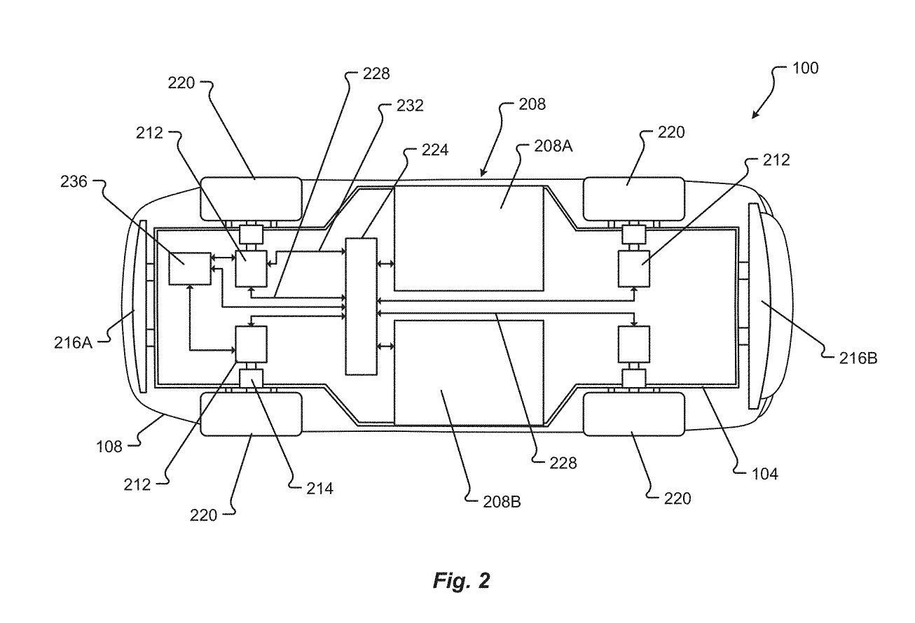

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208A, 208B, motors 212, engines, safety equipment, controllers, user interfaces, interiors exterior components, body panels 108, bumpers 216, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208A, 208B (e.g., battery unit, capacitor unit, etc.) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

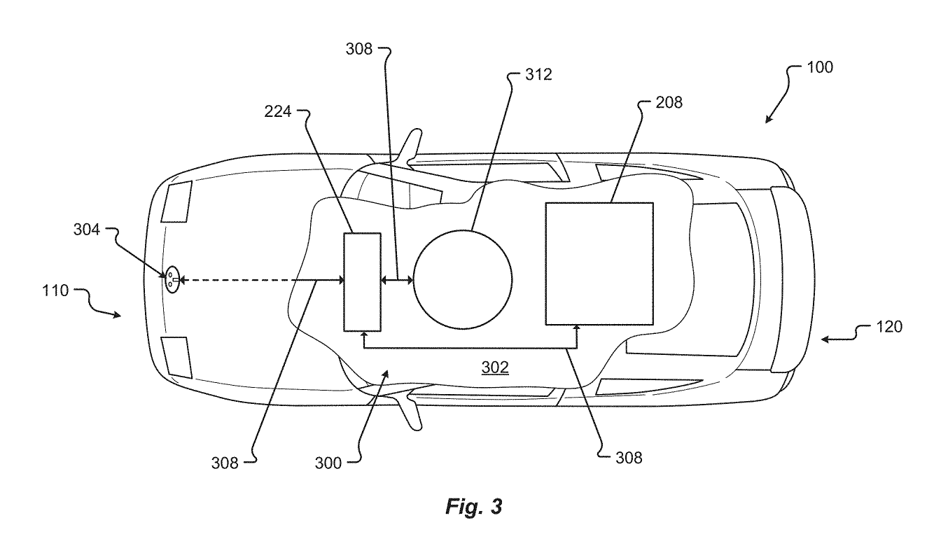

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

The vehicle sensors and systems may be selected and/or configured to suit a level of operation associated with the vehicle 100. Among other things, the number of sensors used in a system may be altered to increase or decrease information available to a vehicle control system (e.g., affecting control capabilities of the vehicle 100). Additionally or alternatively, the sensors and systems may be part of one or more advanced driver assistance systems (ADAS) associated with a vehicle 100. In any event, the sensors and systems may be used to provide driving assistance at any level of operation (e.g., from fully-manual to fully-autonomous operations, etc.) as described herein.

The various levels of vehicle control and/or operation can be described as corresponding to a level of autonomy associated with a vehicle 100 for vehicle driving operations. For instance, at Level 0, or fully-manual driving operations, a driver (e.g., a human driver) may be responsible for all the driving control operations (e.g., steering, accelerating, braking, etc.) associated with the vehicle. Level 0 may be referred to as a “No Automation” level. At Level 1, the vehicle may be responsible for a limited number of the driving operations associated with the vehicle, while the driver is still responsible for most driving control operations. An example of a Level 1 vehicle may include a vehicle in which the throttle control and/or braking operations may be controlled by the vehicle (e.g., cruise control operations, etc.). Level 1 may be referred to as a “Driver Assistance” level. At Level 2, the vehicle may collect information (e.g., via one or more driving assistance systems, sensors, etc.) about an environment of the vehicle (e.g., surrounding area, roadway, traffic, ambient conditions, etc.) and use the collected information to control driving operations (e.g., steering, accelerating, braking, etc.) associated with the vehicle. In a Level 2 autonomous vehicle, the driver may be required to perform other aspects of driving operations not controlled by the vehicle. Level 2 may be referred to as a “Partial Automation” level. It should be appreciated that Levels 0-2 all involve the driver monitoring the driving operations of the vehicle.

At Level 3, the driver may be separated from controlling all the driving operations of the vehicle except when the vehicle makes a request for the operator to act or intervene in controlling one or more driving operations. In other words, the driver may be separated from controlling the vehicle unless the driver is required to take over for the vehicle. Level 3 may be referred to as a “Conditional Automation” level. At Level 4, the driver may be separated from controlling all the driving operations of the vehicle and the vehicle may control driving operations even when a user fails to respond to a request to intervene. Level 4 may be referred to as a “High Automation” level. At Level 5, the vehicle can control all the driving operations associated with the vehicle in all driving modes. The vehicle in Level 5 may continually monitor traffic, vehicular, roadway, and/or environmental conditions while driving the vehicle. In Level 5, there is no human driver interaction required in any driving mode. Accordingly, Level 5 may be referred to as a “Full Automation” level. It should be appreciated that in Levels 3-5 the vehicle, and/or one or more automated driving systems associated with the vehicle, monitors the driving operations of the vehicle and the driving environment.

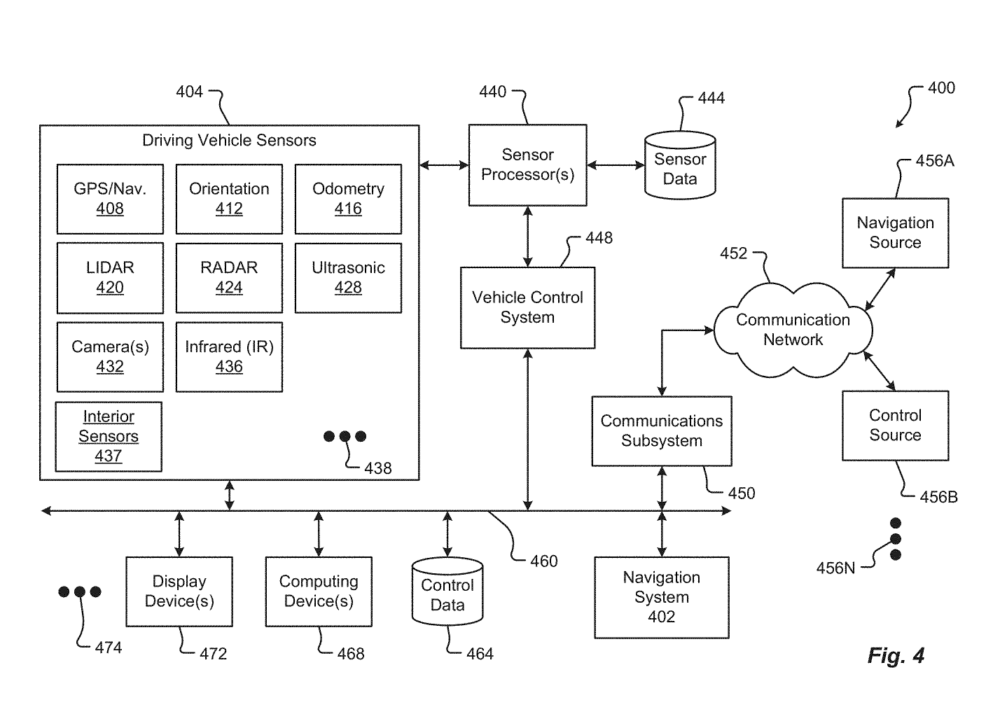

FIG. 4 is a block diagram of an embodiment of a communication environment 400 of the vehicle 100 in accordance with embodiments of the present disclosure. The communication system 400 may include one or more vehicle driving vehicle sensors and systems 404, sensor processors 440, sensor data memory 444, vehicle control system 448, communications subsystem 450, control data 464, computing devices 468, display devices 472, and other components 474 that may be associated with a vehicle 100. These associated components may be electrically and/or communicatively coupled to one another via at least one bus 460. In some embodiments, the one or more associated components may send and/or receive signals across a communication network 452 to at least one of a navigation source 456A, a control source 456B, or some other entity 456N.

In accordance with at least some embodiments of the present disclosure, the communication network 452 may comprise any type of known communication medium or collection of communication media and may use any type of protocols, such as SIP, TCP/IP, SNA, IPX, AppleTalk, and the like, to transport messages between endpoints. The communication network 452 may include wired and/or wireless communication technologies. The Internet is an example of the communication network 452 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), such as an Ethernet network, a Token-Ring network and/or the like, a Wide Area Network (WAN), a virtual network, including without limitation a virtual private network (“VPN”); the Internet, an intranet, an extranet, a cellular network, an infra-red network; a wireless network (e.g., a network operating under any of the IEEE 802.9 suite of protocols, the Bluetooth® protocol known in the art, and/or any other wireless protocol), and any other type of packet-switched or circuit-switched network known in the art and/or any combination of these and/or other networks. In addition, it can be appreciated that the communication network 452 need not be limited to any one network type, and instead may be comprised of a number of different networks and/or network types. The communication network 452 may comprise a number of different communication media such as coaxial cable, copper cable/wire, fiber-optic cable, antennas for transmitting/receiving wireless messages, and combinations thereof.

The driving vehicle sensors and systems 404 may include at least one navigation 408 (e.g., global positioning system (GPS), etc.), orientation 412, odometry 416, LIDAR 420, RADAR 424, ultrasonic 428, camera 432, infrared (IR) 436, and/or other sensor or system 438.

The navigation sensor 408 may include one or more sensors having receivers and antennas that are configured to utilize a satellite-based navigation system including a network of navigation satellites capable of providing geolocation and time information to at least one component of the vehicle 100. Examples of the navigation sensor 408 as described herein may include, but are not limited to, at least one of Garmin® GLO™ family of GPS and GLONASS combination sensors, Garmin® GPS 15x™ family of sensors, Garmin® GPS 16x™ family of sensors with high-sensitivity receiver and antenna, Garmin® GPS 18x OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture.

The orientation sensor 412 may include one or more sensors configured to determine an orientation of the vehicle 100 relative to at least one reference point. In some embodiments, the orientation sensor 412 may include at least one pressure transducer, stress/strain gauge, accelerometer, gyroscope, and/or geomagnetic sensor. Examples of the navigation sensor 408 as described herein may include, but are not limited to, at least one of Bosch Sensortec BMX 160 series low-power absolute orientation sensors, Bosch Sensortec BMX055 9-axis sensors, Bosch Sensortec BMI055 6-axis inertial sensors, Bosch Sensortec BMI160 6-axis inertial sensors, Bosch Sensortec BMF055 9-axis inertial sensors (accelerometer, gyroscope, and magnetometer) with integrated Cortex M0+ microcontroller, Bosch Sensortec BMP280 absolute barometric pressure sensors, Infineon TLV493D-A1B6 3D magnetic sensors, Infineon TLI493D-W1B6 3D magnetic sensors, Infineon TL family of 3D magnetic sensors, Murata Electronics SCC2000 series combined gyro sensor and accelerometer, Murata Electronics SCC1300 series combined gyro sensor and accelerometer, other industry-equivalent orientation sensors and/or systems, which may perform orientation detection and/or determination functions using any known or future-developed standard and/or architecture.

The odometry sensor and/or system 416 may include one or more components that is configured to determine a change in position of the vehicle 100 over time. In some embodiments, the odometry system 416 may utilize data from one or more other sensors and/or systems 404 in determining a position (e.g., distance, location, etc.) of the vehicle 100 relative to a previously measured position for the vehicle 100. Additionally or alternatively, the odometry sensors 416 may include one or more encoders, Hall speed sensors, and/or other measurement sensors/devices configured to measure a wheel speed, rotation, and/or number of revolutions made over time. Examples of the odometry sensor/system 416 as described herein may include, but are not limited to, at least one of Infineon TLE4924/26/27/28C high-performance speed sensors, Infineon TL4941plusC(B) single chip differential Hall wheel-speed sensors, Infineon TL5041plusC Giant Mangnetoresistance (GMR) effect sensors, Infineon TL family of magnetic sensors, EPC Model 25SP Accu-CoderPro™ incremental shaft encoders, EPC Model 30M compact incremental encoders with advanced magnetic sensing and signal processing technology, EPC Model 925 absolute shaft encoders, EPC Model 958 absolute shaft encoders, EPC Model MA36S/MA63S/SA36S absolute shaft encoders, Dynapar™ F18 commutating optical encoder, Dynapar™ HS35R family of phased array encoder sensors, other industry-equivalent odometry sensors and/or systems, and may perform change in position detection and/or determination functions using any known or future-developed standard and/or architecture.

The LIDAR sensor/system 420 may include one or more components configured to measure distances to targets using laser illumination. In some embodiments, the LIDAR sensor/system 420 may provide 3D imaging data of an environment around the vehicle 100. The imaging data may be processed to generate a full 360-degree view of the environment around the vehicle 100. The LIDAR sensor/system 420 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LIDAR sensor/system 420 into a measurement environment. The rotating reflective surface may be configured to continually rotate 360 degrees about an axis, such that the plurality of laser beams is directed in a full 360-degree range around the vehicle 100. A photodiode receiver of the LIDAR sensor/system 420 may detect when light from the plurality of laser beams emitted into the measurement environment returns (e.g., reflected echo) to the LIDAR sensor/system 420. The LIDAR sensor/system 420 may calculate, based on a time associated with the emission of light to the detected return of light, a distance from the vehicle 100 to the illuminated target. In some embodiments, the LIDAR sensor/system 420 may generate over 2.0 million points per second and have an effective operational range of at least 100 meters. Examples of the LIDAR sensor/system 420 as described herein may include, but are not limited to, at least one of Velodyne® LiDAR™ HDL-64E 64-channel LIDAR sensors, Velodyne® LiDAR™ HDL-32E 32-channel LIDAR sensors, Velodyne® LiDAR™ PUCK™ VLP-16 16-channel LIDAR sensors, Leica Geosystems Pegasus:Two mobile sensor platform, Garmin® LIDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LIDAR sensors and/or systems, and may perform illuminated target and/or obstacle detection in an environment around the vehicle 100 using any known or future-developed standard and/or architecture.

The RADAR sensors 424 may include one or more radio components that are configured to detect objects/targets in an environment of the vehicle 100. In some embodiments, the RADAR sensors 424 may determine a distance, position, and/or movement vector (e.g., angle, speed, etc.) associated with a target over time. The RADAR sensors 424 may include a transmitter configured to generate and emit electromagnetic waves (e.g., radio, microwaves, etc.) and a receiver configured to detect returned electromagnetic waves. In some embodiments, the RADAR sensors 424 may include at least one processor configured to interpret the returned electromagnetic waves and determine locational properties of targets. Examples of the RADAR sensors 424 as described herein may include, but are not limited to, at least one of Infineon RASIC™ RTN7735PL transmitter and RRN7745PL/46PL receiver sensors, Autoliv ASP Vehicle RADAR sensors, Delphi L2C0051TR 77GHz ESR Electronically Scanning Radar sensors, Fujitsu Ten Ltd. Automotive Compact 77GHz 3D Electronic Scan Millimeter Wave Radar sensors, other industry-equivalent RADAR sensors and/or systems, and may perform radio target and/or obstacle detection in an environment around the vehicle 100 using any known or future-developed standard and/or architecture.

The ultrasonic sensors 428 may include one or more components that are configured to detect objects/targets in an environment of the vehicle 100. In some embodiments, the ultrasonic sensors 428 may determine a distance, position, and/or movement vector (e.g., angle, speed, etc.) associated with a target over time. The ultrasonic sensors 428 may include an ultrasonic transmitter and receiver, or transceiver, configured to generate and emit ultrasound waves and interpret returned echoes of those waves. In some embodiments, the ultrasonic sensors 428 may include at least one processor configured to interpret the returned ultrasonic waves and determine locational properties of targets. Examples of the ultrasonic sensors 428 as described herein may include, but are not limited to, at least one of Texas Instruments TIDA-00151 automotive ultrasonic sensor interface IC sensors, MaxBotix® MB8450 ultrasonic proximity sensor, MaxBotix® ParkSonar™-EZ ultrasonic proximity sensors, Murata Electronics MA40H1S-R open-structure ultrasonic sensors, Murata Electronics MA40S4R/S open-structure ultrasonic sensors, Murata Electronics MA58MF14-7N waterproof ultrasonic sensors, other industry-equivalent ultrasonic sensors and/or systems, and may perform ultrasonic target and/or obstacle detection in an environment around the vehicle 100 using any known or future-developed standard and/or architecture.

The camera sensors 432 may include one or more components configured to detect image information associated with an environment of the vehicle 100. In some embodiments, the camera sensors 432 may include a lens, filter, image sensor, and/or a digital image processer. It is an aspect of the present disclosure that multiple camera sensors 432 may be used together to generate stereo images providing depth measurements. Examples of the camera sensors 432 as described herein may include, but are not limited to, at least one of ON Semiconductor® MT9V024 Global Shutter VGA GS CMOS image sensors, Teledyne DALSA Falcon2 camera sensors, CMOSIS CMV50000 high-speed CMOS image sensors, other industry-equivalent camera sensors and/or systems, and may perform visual target and/or obstacle detection in an environment around the vehicle 100 using any known or future-developed standard and/or architecture.

The infrared (IR) sensors 436 may include one or more components configured to detect image information associated with an environment of the vehicle 100. The IR sensors 436 may be configured to detect targets in low-light, dark, or poorly-lit environments. The IR sensors 436 may include an IR light emitting element (e.g., IR light emitting diode (LED), etc.) and an IR photodiode. In some embodiments, the IR photodiode may be configured to detect returned IR light at or about the same wavelength to that emitted by the IR light emitting element. In some embodiments, the IR sensors 436 may include at least one processor configured to interpret the returned IR light and determine locational properties of targets. The IR sensors 436 may be configured to detect and/or measure a temperature associated with a target (e.g., an object, pedestrian, other vehicle, etc.). Examples of IR sensors 436 as described herein may include, but are not limited to, at least one of Opto Diode lead-salt IR array sensors, Opto Diode OD-850 Near-IR LED sensors, Opto Diode SA/SHA727 steady state IR emitters and IR detectors, FLIR® LS microbolometer sensors, FLIR® TacFLIR 380-HD InSb MWIR FPA and HD MWIR thermal sensors, FLIR® VOx 640×480 pixel detector sensors, Delphi IR sensors, other industry-equivalent IR sensors and/or systems, and may perform IR visual target and/or obstacle detection in an environment around the vehicle 100 using any known or future-developed standard and/or architecture.

A navigation system 402 can include any hardware and/or software used to navigate the vehicle either manually or autonomously.

In some embodiments, the driving vehicle sensors and systems 404 may include other sensors 438 and/or combinations of the sensors 406-437 described above. Additionally or alternatively, one or more of the sensors 406-437 described above may include one or more processors configured to process and/or interpret signals detected by the one or more sensors 406-437. In some embodiments, the processing of at least some sensor information provided by the vehicle sensors and systems 404 may be processed by at least one sensor processor 440. Raw and/or processed sensor data may be stored in a sensor data memory 444 storage medium. In some embodiments, the sensor data memory 444 may store instructions used by the sensor processor 440 for processing sensor information provided by the sensors and systems 404. In any event, the sensor data memory 444 may be a disk drive, optical storage device, solid-state storage device such as a random-access memory (“RAM”) and/or a read-only memory (“ROM”), which can be programmable, flash-updateable, and/or the like.

The vehicle control system 448 may receive processed sensor information from the sensor processor 440 and determine to control an aspect of the vehicle 100. Controlling an aspect of the vehicle 100 may include presenting information via one or more display devices 472 associated with the vehicle, sending commands to one or more computing devices 468 associated with the vehicle, and/or controlling a driving operation of the vehicle. In some embodiments, the vehicle control system 448 may correspond to one or more computing systems that control driving operations of the vehicle 100 in accordance with the Levels of driving autonomy described above. In one embodiment, the vehicle control system 448 may operate a speed of the vehicle 100 by controlling an output signal to the accelerator and/or braking system of the vehicle. In this example, the vehicle control system 448 may receive sensor data describing an environment surrounding the vehicle 100 and, based on the sensor data received, determine to adjust the acceleration, power output, and/or braking of the vehicle 100. The vehicle control system 448 may additionally control steering and/or other driving functions of the vehicle 100.

The vehicle control system 448 may communicate, in real-time, with the driving sensors and systems 404 forming a feedback loop. In particular, upon receiving sensor information describing a condition of targets in the environment surrounding the vehicle 100, the vehicle control system 448 may autonomously make changes to a driving operation of the vehicle 100. The vehicle control system 448 may then receive subsequent sensor information describing any change to the condition of the targets detected in the environment as a result of the changes made to the driving operation. This continual cycle of observation (e.g., via the sensors, etc.) and action (e.g., selected control or non-control of vehicle operations, etc.) allows the vehicle 100 to operate autonomously in the environment.

In some embodiments, the one or more components of the vehicle 100 (e.g., the driving vehicle sensors 404, vehicle control system 448, display devices 472, etc.) may communicate across the communication network 452 to one or more entities 456A-N via a communications subsystem 450 of the vehicle 100. For instance, the navigation sensors 408 may receive global positioning, location, and/or navigational information from a navigation source 456A. In some embodiments, the navigation source 456A may be a global navigation satellite system (GNSS) similar, if not identical, to NAVSTAR GPS, GLONASS, EU Galileo, and/or the BeiDou Navigation Satellite System (BDS) to name a few.

In some embodiments, the vehicle control system 448 may receive control information from one or more control sources 456B. The control source 456 may provide vehicle control information including autonomous driving control commands, vehicle operation override control commands, and the like. The control source 456 may correspond to an autonomous vehicle control system, a traffic control system, an administrative control entity, and/or some other controlling server. It is an aspect of the present disclosure that the vehicle control system 448 and/or other components of the vehicle 100 may exchange communications with the control source 456 across the communication network 452 and via the communications subsystem 450.

Information associated with controlling driving operations of the vehicle 100 may be stored in a control data memory 464 storage medium. The control data memory 464 may store instructions used by the vehicle control system 448 for controlling driving operations of the vehicle 100, historical control information, autonomous driving control rules, and the like. In some embodiments, the control data memory 464 may be a disk drive, optical storage device, solid-state storage device such as a random-access memory (“RAM”) and/or a read-only memory (“ROM”), which can be programmable, flash-updateable, and/or the like.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

For an autonomous, semi-autonomous, or manually operated electric vehicle 100 as described above, thermal management is critical. For example, the batteries or other power source, inverters, drive motors, and other electrical components need to be sufficiently cooled. Failure to provide sufficient cooling to these components can result in damage or even catastrophic failure of the components. Autonomous vehicles in particular must prove to be resilient to avoid such failures and continue to operate in a safe manner until the vehicle can be driven to a repair location or at least removed from a roadway to a shoulder or parking area.

According to one embodiment, resiliency of the cooling system can be provided by reducing the number of independent loops in the plumbing of the cooling system rather than providing additional, redundant loops. More specifically, coolant plumbing loops can be connected together and valves between the otherwise independent loops can be controlled to change the coolant flow within and between the loops to direct coolant to the various components requiring cooling in the event of a failure of an element of the cooling system such as a pump. That is, rather than providing a set of substantially parallel or otherwise redundant coolant plumbing between equipment such as heat exchangers, cooling plates, etc., separate loops between these elements can be interconnected with valves between the separate loops. These valves can be operated to maintain the separation between the independent loops in normal operation but, upon the failure of a pump supplying one of the loops, can be operated to allow coolant flow between the loops and thereby eliminating the need for redundant pumps to maintain coolant function in the event of a pump failure.

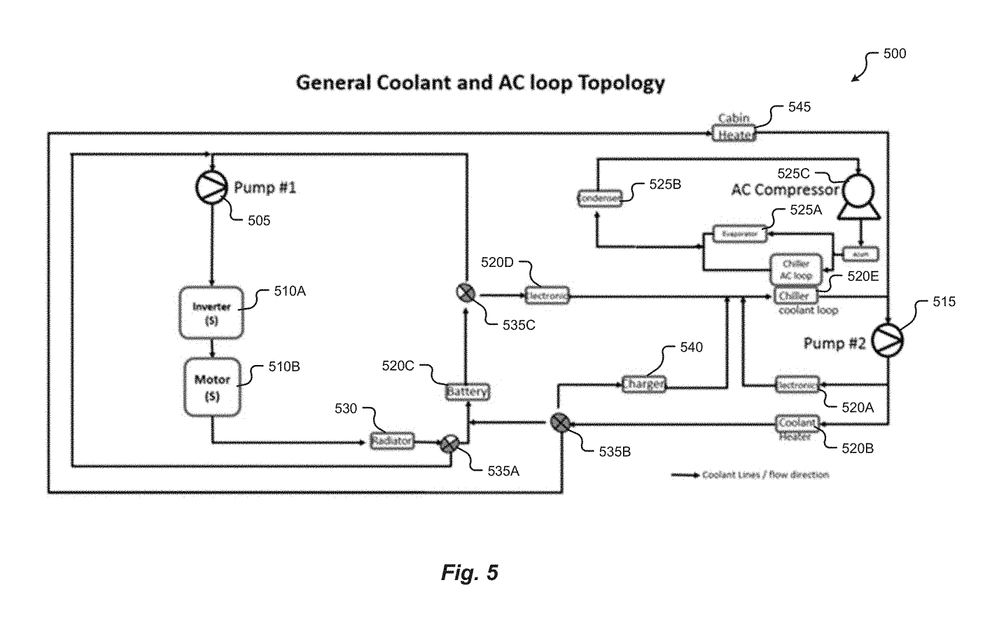

FIG. 5 is a schematic illustrating a topology of an exemplary vehicle cooling system according to one embodiment of the present disclosure. As illustrated in this example, the vehicle cooling system 500 can comprise a first coolant pump 505 and a first set of one or more thermal sources 510A and 510B. As illustrated here, the first set of thermal sources can comprise, for example, one or more vehicle drive components such as one or more inverters 510A and/or drive motors 510B. A first set of coolant plumbing, illustrated here as the lines connecting the first coolant pump 505 and first set of heat sources 510A and 510B and as will be described in greater detail below, can be coupled with the first coolant pump 505 and first set of heat sources 510A and 510B. The first coolant pump 505 can operate to circulate coolant through the first set of coolant plumbing to the first set of one or more thermal sources 510A and 510B.

The system 500 can further comprise a second coolant pump 515 and a second set of one or more thermal sources 520A-520E. As illustrated here, the second set of thermal sources can comprise, for example, one or more vehicle components, other than drive components, such as electronic controls or components 520A and 520D, a coolant heater 520B, a battery or battery pack 520C, and/or a chiller 520E of a cabin air conditioning loop. As illustrated here and as known in the art, the cabin air conditioning loop can further comprise an evaporator 525A, condenser 525B, and compressor 525C. A second set of coolant plumbing, illustrated here as the lines connecting the second coolant pump 515 and second set of heat sources 520A-520E and as will be described in greater detail below, can be coupled with the second coolant pump 515 and second set of heat sources 520A-520E. The second coolant pump 515 can operate to circulate coolant through the second set of coolant plumbing to the second set of one or more thermal sources 520A-520E.

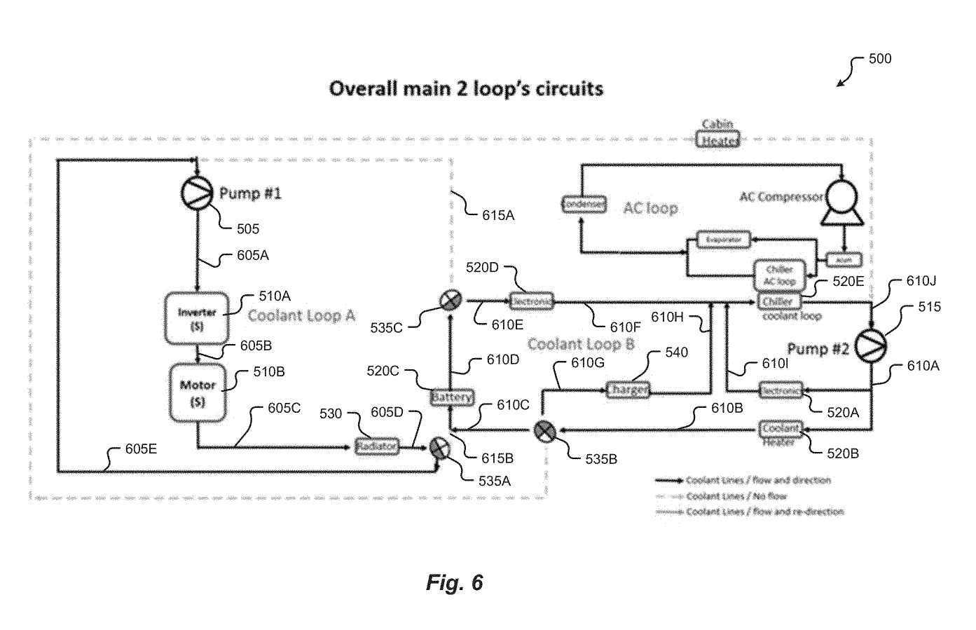

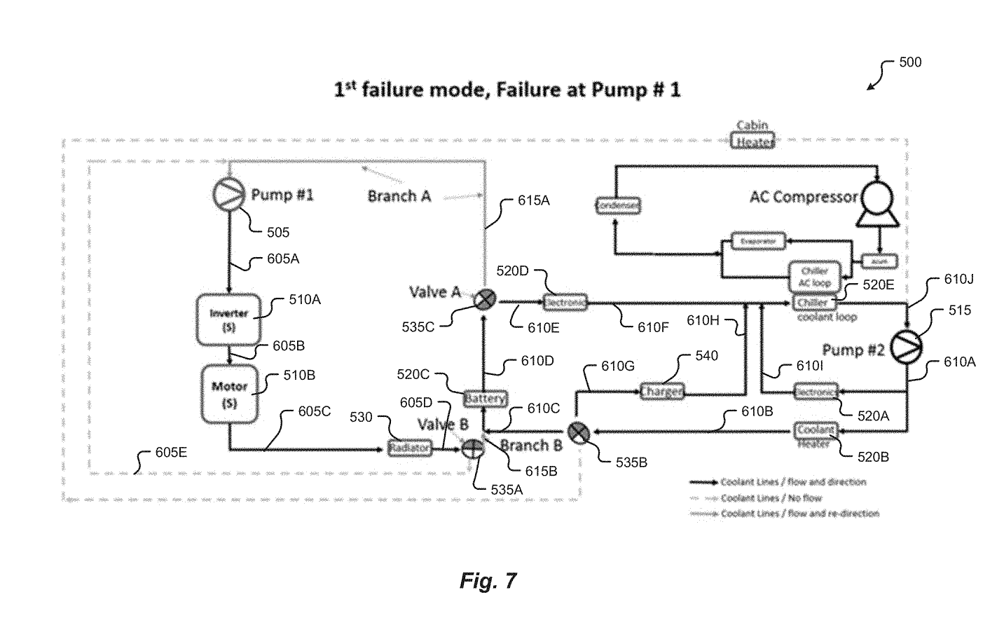

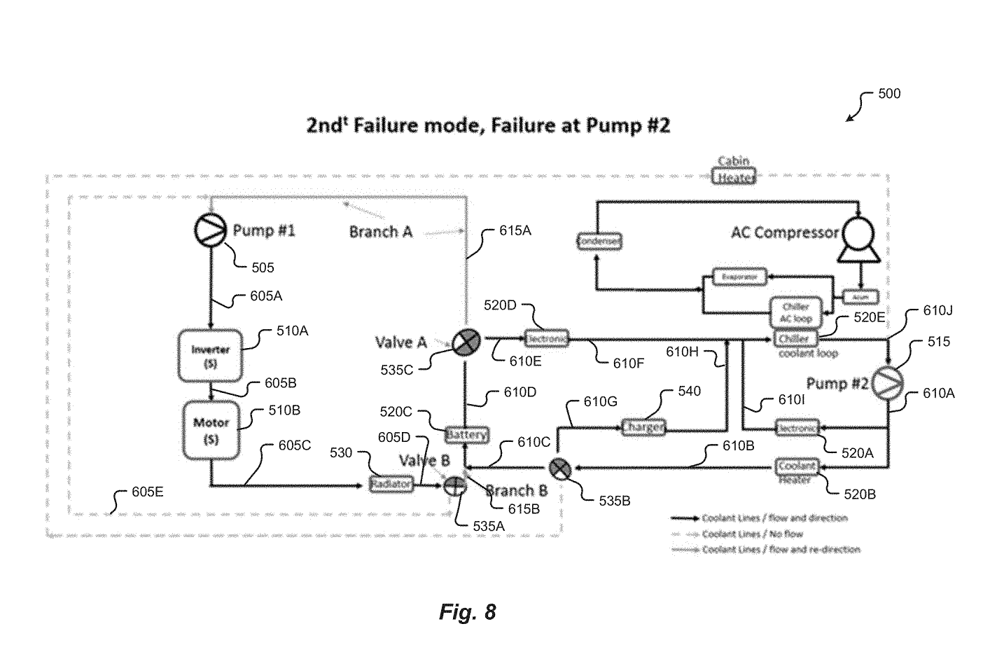

A plurality of valves 535A-535C can be coupled with or disposed within the coolant plumbing the coolant plumbing. Generally speaking and as will be described in greater detail below, the valves 535A-535C can be operated in a plurality of modes by a control system 448 of the vehicle as described above to inhibit and/or redirect coolant flow through the first set of coolant plumbing and the second set of coolant plumbing. According to one embodiment, the plurality of modes can comprise a normal operation mode in which coolant plumbing is isolated by the valves 535A-535C into two separate loops as will be described below with reference to FIG. 6 and one or more failure modes as will be described below with reference to FIGS. 7 and 8 in which the coolant flow in the plumbing can be redirected between the loops so that either pump 505 or 515 can circulate coolant through the entire system 500 upon a partial or complete failure of the other pump 505 or 515. Additionally, one or more valves may be adapted to redirect coolant flow to elements of the system on an “as needed” or on demand basis. For example, valve 535B can be operated by a control system 448 of the vehicle to direct coolant flow through a charger 540 and/or a cabin heater 545 as needed.

FIG. 6 is a schematic illustrating the exemplary vehicle cooling system in a normal operation mode according to one embodiment of the present disclosure. As illustrated in this example, when both coolant pumps 505 and 515 are operating normally, the valves 535A-535C can be operated to isolate the coolant plumbing into two separate coolant loops. More specifically, a first set of coolant plumbing 605A-605E coupled with the first coolant pump 505 and the first set of thermal sources 510A and 510B can comprise the first coolant loop while a second set of coolant plumbing 610A-610J coupled with the second coolant pump 515 and the second set of thermal sources 520A-520E can comprise the second coolant loop. Additionally, the system 500 can include a set of redirection plumbing 615A and 615B which, in a failure mode, can be used along with the valves 535A and 535C to redirect coolant flow as will be described below.

In the normal operation mode as illustrated here, the first coolant pump 505 is operating by the control system 448 of the vehicle to circulate coolant through the first set of coolant plumbing 605A-605E to the first set of one or more thermal sources 510A and 510B, the second coolant pump 515 is operating by the control system 448 to circulate coolant through the second set of coolant plumbing 610A-610J to the second set of thermal sources 520A-520E, and valves 535A and 535C can be operated by the control system 448 to isolate and prevent coolant flow between the first set of coolant plumbing 605A-605E and the second set of coolant plumbing 610A-6101

FIG. 7 is a schematic illustrating the exemplary vehicle cooling system in a first failure operation mode according to one embodiment of the present disclosure. As known in the art, the coolant pumps 505 and 515 can provide a variety of information to the control system 448 of the vehicle such as RPM, pressure, flow rate, and health status. Based on this information, the control system 448 can detect a current or imminent, partial or complete failure of either of the pumps 505 or 515. This example illustrates a failure mode of operation for the cooling system 500 when the first coolant pump 505 has failed. As illustrated here, when the first coolant pump 505 fails, valves 535A and 535C can be operated by the control system 448 to redirect coolant flow from the second set of coolant plumbing 610A-610J through first set of coolant plumbing 605A-605E, and redirection plumbing 615A and 615B and the second coolant pump 515 can then circulate coolant through both of the first set of coolant plumbing 605A-605E and redirection plumbing 615A and 615B to the first set of one or more thermal sources 510A and 510B and the second set of coolant plumbing 610A-610J to the second set of one or more thermal sources 520A-520E.

FIG. 8 is a schematic illustrating the exemplary vehicle cooling system in a second failure operation mode according to one embodiment of the present disclosure. More specifically, this example illustrates a failure mode of operation for the cooling system 500 when the second coolant pump 515 has failed. As illustrated here, when the second coolant pump 515 fails, valves 535A and 535C can be operated by the control system 448 to redirect coolant flow from the first set of coolant plumbing plumbing 605A-605E and redirection plumbing 615A and 615B through the second set of coolant plumbing 610A-610J, and the first coolant pump 505 can then circulate coolant through both of the first set of coolant plumbing plumbing 605A-605E and redirection plumbing 615A and 615B to the first set of one or more thermal sources 510A and 510B and the second set of coolant plumbing 610A-610J to the second set of one or more thermal sources 520A-520E.

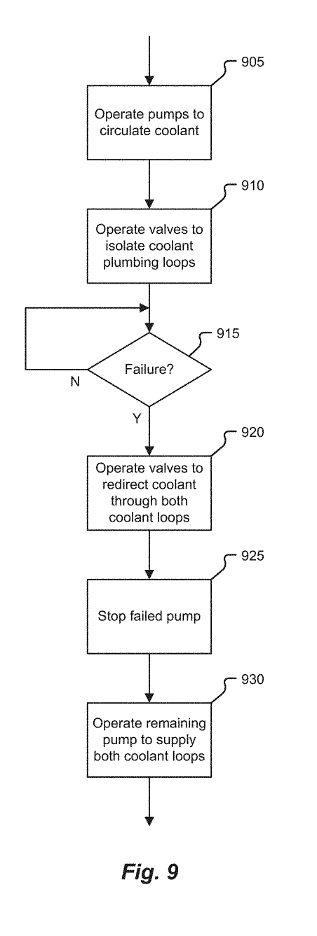

FIG. 9 is a flowchart illustrating an exemplary process for controlling a vehicle cooling system according to one embodiment of the present disclosure. As illustrated in this example, controlling a cooling system of a vehicle can comprise operating 905 a first coolant pump coupled with a first set of coolant plumbing to circulate coolant through the first set of coolant plumbing to a first set of one or more thermal sources. A second coolant pump coupled with a second set of coolant plumbing can also be operated 905 to circulate coolant through the second set of coolant plumbing to a second set of one or more thermal sources. For example, the first set of one or more thermal sources can comprise one or more of an inverter, a drive motor, etc. and the second set of one or more thermal sources can comprise one or more of a cabin cooling system of an electronic control system of the vehicle.

A plurality of valves coupled with the first set of coolant plumbing and the second set of coolant plumbing can be operated 910 in a plurality of modes to isolate or redirect coolant flow through the first set of coolant plumbing and the second set of coolant plumbing. More specifically, the plurality of modes can comprise a first mode of operation comprising operating 910 the plurality of valves to isolate and prevent coolant flow between the first set of coolant plumbing and the second set of coolant plumbing.

During operation, a failure can be detected 915 and the operational mode can be changed to remediate this failure. For example, a failure of the first coolant pump can be detected 915 and a second mode of operation can be initiated comprising operating 920 the plurality of valves to redirect coolant flow from the second set of coolant plumbing through first set of coolant plumbing. In another case, a failure of the second coolant pump can be detected 915 and a third mode of operation can be initiated comprising operating 920 the plurality of valves to redirect coolant flow from the first set of coolant plumbing through second set of coolant plumbing. In either case, the failed pump may be stopped 925 since the other pump is now circulating cooling through both loops. In other implementations, and depending upon the severity of the detected failure, the failed pump may continue to operate but at a diminished capacity, e.g., lower RPM, etc. In either case, the remaining, non-failed pump can continue 930 to operate 930 to supply both coolant loops and thereby provide failsafe operation while the vehicle is navigated to a safe location and brought to a controlled, safe stop until it can be repaired.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a vehicle cooling system comprising: a first coolant pump; a first set of coolant plumbing coupled with the first coolant pump and a first set of one or more thermal sources, wherein the first coolant pump operates to circulate coolant through the first set of coolant plumbing to the first set of one or more thermal sources; a second coolant pump; a second set of coolant plumbing coupled with the second coolant pump and a second set of one or more thermal sources, wherein the second coolant pump operates to circulate coolant through the second set of coolant plumbing to the second set of one or more thermal sources; and a plurality of valves coupled with the first set of coolant plumbing and the second set of coolant plumbing, wherein the plurality of valves operates in a plurality of modes to redirect coolant flow through the first set of coolant plumbing and the second set of coolant plumbing.

Aspects of the above vehicle cooling system include wherein the plurality of modes comprises a first mode of operation wherein the first coolant pump is operating to circulate coolant through the first set of coolant plumbing to the first set of one or more thermal sources, the second coolant pump is operating to circulate coolant through the second set of coolant plumbing, and the plurality of valves are operated to isolate and prevent coolant flow between the first set of coolant plumbing and the second set of coolant plumbing.

Aspects of the above vehicle cooling system include wherein the plurality of modes further comprises a second mode of operation wherein, when the first coolant pump fails, the plurality of valves operate to redirect coolant flow from the second set of coolant plumbing through first set of coolant plumbing, and the second coolant pump operates to circulate coolant through both of the first set of coolant plumbing to the first set of one or more thermal sources and the second set of coolant plumbing to the second set of one or more thermal sources.

Aspects of the above vehicle cooling system include wherein the plurality of modes further comprises a third mode of operation wherein, when the second coolant pump fails, the plurality of valves operate to redirect coolant flow from the first set of coolant plumbing through second set of coolant plumbing, and the first coolant pump operates to circulate coolant through both of the first set of coolant plumbing to the first set of one or more thermal sources and the second set of coolant plumbing to the second set of one or more thermal sources.

Aspects of the above vehicle cooling system include wherein the first set of one or more thermal sources comprises one or more vehicle drive components and the second set of one or more thermal sources comprises one or more components other than vehicle drive components.

Aspects of the above vehicle cooling system include wherein the first set of one or more thermal sources comprises one or more of an inverter or a drive motor.

Aspects of the above vehicle cooling system include wherein the second set of one or more thermal sources comprises one or more of a cabin cooling system of an electronic control system of the vehicle.

Embodiments include a vehicle comprising: a first set of one or more thermal sources; a second set of one or more thermal sources; a first coolant pump; a first set of coolant plumbing coupled with the first coolant pump and the first set of one or more thermal sources, wherein the first coolant pump operates to circulate coolant through the first set of coolant plumbing to the first set of one or more thermal sources; a second coolant pump; a second set of coolant plumbing coupled with the second coolant pump and the second set of one or more thermal sources, wherein the second coolant pump operates to circulate coolant through the second set of coolant plumbing to the second set of one or more thermal sources; a plurality of valves coupled with the first set of coolant plumbing and the second set of coolant plumbing; and a cooling system controller electronically coupled with and operating the plurality of valves in a plurality of modes to redirect coolant flow through the first set of coolant plumbing and the second set of coolant plumbing.

Aspects of the above vehicle include wherein the plurality of modes comprises a first mode of operation wherein the first coolant pump is operated by the cooling system controller to circulate coolant through the first set of coolant plumbing to the first set of one or more thermal sources, the second coolant pump is operated by the cooling system controller to circulate coolant through the second set of coolant plumbing, and the plurality of valves are operated by the cooling system controller to isolate and prevent coolant flow between the first set of coolant plumbing and the second set of coolant plumbing.

Aspects of the above vehicle include wherein the plurality of modes further comprises a second mode of operation wherein, when the first coolant pump fails, the plurality of valves is operated by the cooling system controller to redirect coolant flow from the second set of coolant plumbing through first set of coolant plumbing, and the second coolant pump is operated by the cooling system controller to circulate coolant through both of the first set of coolant plumbing to the first set of one or more thermal sources and the second set of coolant plumbing to the second set of one or more thermal sources.

Aspects of the above vehicle include wherein the plurality of modes further comprises a third mode of operation wherein, when the second coolant pump fails, the plurality of valves is operated by the cooling system controller to redirect coolant flow from the first set of coolant plumbing through second set of coolant plumbing, and the first coolant pump is operated by the cooling system controller to circulate coolant through both of the first set of coolant plumbing to the first set of one or more thermal sources and the second set of coolant plumbing to the second set of one or more thermal sources.

Aspects of the above vehicle include wherein the first set of one or more thermal sources comprises one or more vehicle drive components and the second set of one or more thermal sources comprises one or more components other than vehicle drive components.

Aspects of the above vehicle include wherein the first set of one or more thermal sources comprises one or more of an inverter or a drive motor.

Aspects of the above vehicle include wherein the second set of one or more thermal sources comprises one or more of a cabin cooling system of an electronic control system of the vehicle.

Embodiments include a method for controlling a cooling system of a vehicle, the method comprising: operating a first coolant pump coupled with a first set of coolant plumbing to circulate coolant through the first set of coolant plumbing to a first set of one or more thermal sources; operating a second coolant pump coupled with a second set of coolant plumbing to circulate coolant through the second set of coolant plumbing to a second set of one or more thermal sources; and operating a plurality of valves coupled with the first set of coolant plumbing and the second set of coolant plumbing in a plurality of modes to isolate or redirect coolant flow through the first set of coolant plumbing and the second set of coolant plumbing.

Aspects of the above method include wherein the plurality of modes comprises a first mode of operation comprising operating the plurality of valves to isolate and prevent coolant flow between the first set of coolant plumbing and the second set of coolant plumbing.

Aspects of the above method further include detecting a failure of the first coolant pump and initiating a second mode of operation comprising operating the plurality of valves to redirect coolant flow from the second set of coolant plumbing through first set of coolant plumbing.

Aspects of the above method further include detecting a failure of the second coolant pump and initiating a third mode of operation comprising operating the plurality of valves to redirect coolant flow from the first set of coolant plumbing through second set of coolant plumbing.

Aspects of the above method include wherein the first set of one or more thermal sources comprises one or more of an inverter or a drive motor.

Aspects of the above method include wherein the second set of one or more thermal sources comprises one or more of a cabin cooling system of an electronic control system of the vehicle.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A vehicle cooling system comprising:
a first coolant pump;
a first set of coolant plumbing coupled with the first coolant pump and a first set of one or more thermal sources, wherein the first coolant pump operates to circulate coolant through the first set of coolant plumbing to the first set of one or more thermal sources;
a second coolant pump;
a second set of coolant plumbing coupled with the second coolant pump and a second set of one or more thermal sources, wherein the second coolant pump operates to circulate coolant through the second set of coolant plumbing to the second set of one or more thermal sources; and
a plurality of valves coupled with the first set of coolant plumbing and the second set of coolant plumbing, wherein the plurality of valves operates in a plurality of modes to redirect coolant flow through the first set of coolant plumbing and the second set of coolant plumbing.

2. The vehicle cooling system of claim 1, wherein the plurality of modes comprises a first mode of operation wherein the first coolant pump is operating to circulate coolant through the first set of coolant plumbing to the first set of one or more thermal sources, the second coolant pump is operating to circulate coolant through the second set of coolant plumbing, and the plurality of valves are operated to isolate and prevent coolant flow between the first set of coolant plumbing and the second set of coolant plumbing.

3. The vehicle cooling system of claim 2, wherein the plurality of modes further comprises a second mode of operation wherein, when the first coolant pump fails, the plurality of valves operate to redirect coolant flow from the second set of coolant plumbing through first set of coolant plumbing, and the second coolant pump operates to circulate coolant through both of the first set of coolant plumbing to the first set of one or more thermal sources and the second set of coolant plumbing to the second set of one or more thermal sources.

4. The vehicle cooling system of claim 3, wherein the plurality of modes further comprises a third mode of operation wherein, when the second coolant pump fails, the plurality of valves operate to redirect coolant flow from the first set of coolant plumbing through second set of coolant plumbing, and the first coolant pump operates to circulate coolant through both of the first set of coolant plumbing to the first set of one or more thermal sources and the second set of coolant plumbing to the second set of one or more thermal sources.

5. The vehicle cooling system of claim 1, wherein the first set of one or more thermal sources comprises one or more vehicle drive components and the second set of one or more thermal sources comprises one or more components other than vehicle drive components.

6. The vehicle cooling system of claim 1, wherein the first set of one or more thermal sources comprises one or more of an inverter or a drive motor.

7. The vehicle cooling system of claim 6, wherein the second set of one or more thermal sources comprises one or more of a cabin cooling system of an electronic control system of the vehicle.

8. A vehicle comprising:
a first set of one or more thermal sources;
a second set of one or more thermal sources;
a first coolant pump;
a first set of coolant plumbing coupled with the first coolant pump and the first set of one or more thermal sources, wherein the first coolant pump operates to circulate coolant through the first set of coolant plumbing to the first set of one or more thermal sources;
a second coolant pump;
a second set of coolant plumbing coupled with the second coolant pump and the second set of one or more thermal sources, wherein the second coolant pump operates to circulate coolant through the second set of coolant plumbing to the second set of one or more thermal sources;
a plurality of valves coupled with the first set of coolant plumbing and the second set of coolant plumbing; and
a cooling system controller electronically coupled with and operating the plurality of valves in a plurality of modes to redirect coolant flow through the first set of coolant plumbing and the second set of coolant plumbing.

9. The vehicle of claim 8, wherein the plurality of modes comprises a first mode of operation wherein the first coolant pump is operated by the cooling system controller to circulate coolant through the first set of coolant plumbing to the first set of one or more thermal sources, the second coolant pump is operated by the cooling system controller to circulate coolant through the second set of coolant plumbing, and the plurality of valves are operated by the cooling system controller to isolate and prevent coolant flow between the first set of coolant plumbing and the second set of coolant plumbing.

10. The vehicle of claim 9, wherein the plurality of modes further comprises a second mode of operation wherein, when the first coolant pump fails, the plurality of valves is operated by the cooling system controller to redirect coolant flow from the second set of coolant plumbing through first set of coolant plumbing, and the second coolant pump is operated by the cooling system controller to circulate coolant through both of the first set of coolant plumbing to the first set of one or more thermal sources and the second set of coolant plumbing to the second set of one or more thermal sources.

11. The vehicle of claim 10, wherein the plurality of modes further comprises a third mode of operation wherein, when the second coolant pump fails, the plurality of valves is operated by the cooling system controller to redirect coolant flow from the first set of coolant plumbing through second set of coolant plumbing, and the first coolant pump is operated by the cooling system controller to circulate coolant through both of the first set of coolant plumbing to the first set of one or more thermal sources and the second set of coolant plumbing to the second set of one or more thermal sources.

12. The vehicle of claim 8, wherein the first set of one or more thermal sources comprises one or more vehicle drive components and the second set of one or more thermal sources comprises one or more components other than vehicle drive components.

13. The vehicle of claim 8, wherein the first set of one or more thermal sources comprises one or more of an inverter or a drive motor.

14. The vehicle of claim 13, wherein the second set of one or more thermal sources comprises one or more of a cabin cooling system of an electronic control system of the vehicle.

15. A method for controlling a cooling system of a vehicle, the method comprising:
operating a first coolant pump coupled with a first set of coolant plumbing to circulate coolant through the first set of coolant plumbing to a first set of one or more thermal sources;
operating a second coolant pump coupled with a second set of coolant plumbing to circulate coolant through the second set of coolant plumbing to a second set of one or more thermal sources; and
operating a plurality of valves coupled with the first set of coolant plumbing and the second set of coolant plumbing in a plurality of modes to isolate or redirect coolant flow through the first set of coolant plumbing and the second set of coolant plumbing.

16. The method of claim 15, wherein the plurality of modes comprises a first mode of operation comprising operating the plurality of valves to isolate and prevent coolant flow between the first set of coolant plumbing and the second set of coolant plumbing.

17. The method of claim 16, further comprising detecting a failure of the first coolant pump and initiating a second mode of operation comprising operating the plurality of valves to redirect coolant flow from the second set of coolant plumbing through first set of coolant plumbing.

18. The method of claim 17, further comprising detecting a failure of the second coolant pump and initiating a third mode of operation comprising operating the plurality of valves to redirect coolant flow from the first set of coolant plumbing through second set of coolant plumbing.

19. The method of claim 15, wherein the first set of one or more thermal sources comprises one or more of an inverter or a drive motor.

20. The method of claim 19, wherein the second set of one or more thermal sources comprises one or more of a cabin cooling system of an electronic control system of the vehicle.
